(19) United States
(12) Patent Application Publication
(10) Pub. No.: US 2026/0336228 A1
(43) Pub. Date: Oct. 29, 2026

(54) Method and Apparatus for Adhering Sound-Absorbing Material Layer to Noise-Reducing Tire

(71) Applicant: Shanghai Taihe Industrial Co., Ltd., Shanghai (CN)

(72) Inventor: Hong Zhu, Shanghai (CN)

(21) Appl. No.: 18/717,096

(22) PCT Filed: Feb. 19, 2024
(86) PCT No.: PCT/CN2024/077560

§ 371 Date: Jun. 6, 2024

(30) Foreign Application Priority Data
Dec. 22, 2023 (CN) 202311778249.0

(51) Int. Cl. B29C 65/48; B29C 65/52; B29L 30/00

(52) U.S. Cl. CPC B29C 65/4805; B29C 65/52; B29L 2030/00

(57) ABSTRACT

Disclosed herein is a method and an apparatus for adhering sound-absorbing material layer to noise-reducing tire which relates to the technical field of noise-reducing tire production apparatus. It consists of following parts: tire body which is used as base material for adhering and sound-absorbing material layer which is used for absorbing the noise generated by operation of the tire body. The adhesive layer, which is made of two-component silica gel, is coated between tire body and sound-absorbing material layer. The Method for adhering sound-absorbing material layer to noise-reducing tire includes following steps: Sp1 is to prepare tire body, Sp2. is to coat adhesive layer on the inner wall of the tire body and Sp3. is to laminate sound-absorbing material layer to inner wall surface of the tire and adhering it to the tire through adhesive layer.

### TECHNICAL FIELD

The present invention relates to the technical field of noise-reducing tire production apparatus, specifically a method and an apparatus of sound-absorbing material layer for noise-reducing tire.

### TECHNICAL BACKGROUND

Traditional silent pneumatic tires are produced by the following three methods: 1) Liquid rubber (generally used Neoprene) is used as a bonding material, sprayed on the inner wall of the pneumatic tire, and then the sound-absorbing material is adhered to the glue-containing part to make the two fit. 2) The single component silicone is used as a bonding material and adhered to the inner wall of the tire, and then adhered sound-absorbing material. 3) The double-sided adhesive material is used for this method, which is pre-coating to the one side of the sound-absorbing material, and then adhering the sound-absorbing material, together with the double-sided adhesive material, directly to the inner wall of the tire.

The main problems with the prior art solutions for noise reduction and tire sound absorption processing methods are as follows:
1. Problem 1: Mainly, the liquid rubber material (usually chloroprene rubber) is sprayed out in a mist or semi dew state under high pressure, which is difficult to ensure overall uniformity and the spraying range is also difficult to stabilize within a certain range; and the chloroprene rubber material itself has poor temperature resistance, and can only withstand high temperatures of 120 degrees Celsius for a short period of time and its low-temperature use range is generally no less than −20 degrees Celsius; it is sensitive to the process temperature during use (when the ambient temperature exceeds the elastic state temperature, the roller sticky phenomenon will occur, causing difficulties in operation); due to its large crystallization tendency, the adhesive materials gradually harden after long-term storage, resulting in a decrease in adhesion and difficulty in shape processing (especially, W-type neoprene chloroprene rubber); the storage stability of neoprene is poor, and this will lead to plasticity reduction, hardness increasing, shortened scorch time, and accelerated vulcanization rate, that is, in the processing technology, it is manifested as a decrease in the fluidity of the rubber material, a deterioration in adhesion, rough surface of the extruded rubber billet and semi-finished products, and easy burning. In severe cases, it can lead to the scrapping of the rubber material. In addition, such adhesive agent generally contains acetone component, which is toxic, has a particular anesthetic effect on the nervous apparatus, stimulates on the human mucous membrane, and causes dyspnea by inhibiting breathing. Most importantly, it may inhibit and anaesthetize the central nervous apparatus, and may cause damage to liver, kidney and pancreas in the high concentration of exposure. So overall, this process is highly hazardous and unstable.
2. Problem 2: Single-component silicone has a poor initial adhesion, which can easily cause the sound-absorbing materials to fall off during the application process or later transportation process; and single-component silicone generally takes 48 to 72 hours to cure, which will greatly increase the inventory and management cost pressure of tire enterprises.
3. Problem 3: Double-sided adhesive material needs to be pre-processed before it can be adhered: If double-sided tape is first applied to one side of the sound-absorbing material, or if double-sided tape has already been applied, the pre-treatment process of tearing off the double-sided tape isolation layer is relatively complex. Due to the high initial adhesion of double-sided tape and the softness of sponge material, it is easy to encounter adhesion problems caused by the wrinkles of the double-sided tape itself, in addition, the automation equipment for tearing up the double-sided tape isolation layer is relatively complex, which can easily lead to double-sided tape wrinkles and adhesion problems.

### SUMMARY OF THE INVENTION

### Technical Problems Solved by the Invention

Addressing the shortcomings of the prior art, the present invention provides a method and an apparatus for adhering sound-absorbing material layer to noise-reducing tire, which can shorten curing time of glue, improve production efficiency, and reduce storage and management costs.

### Technical Solution

In order to achieve the above purposes, the present invention is implemented the following technical solution: a method for adhering sound-absorbing material layer to noise-reducing tire comprises the following parts:
tire body which is used as base material for adhering;
sound-absorbing material layer which is used for absorbing the noise generated by operation of the tire body, and
an adhesive layer which is coated between tire body and sound-absorbing material layer.

The Method for adhering sound-absorbing material layer to noise-reducing tire includes following steps:
a first step of preparing the tire body;
a second step of coating the adhesive layer on the inner wall of the tire body, and
a third step of laminating the sound-absorbing material layer to inner wall surface of the tire and adhering it to the tire through adhesive layer.

Preferably, the adhesive layer is a two-component silica gel, and the two-component silica gel mixture is divided into component A and component B.

The Component A is divided into polydimethylsiloxane, pigment a (which cannot be added) and filler a, wherein the polydimethylsiloxane accounts for 30% to 60% of the weight of composition A, pigment a accounts for 0% to 2% of the weight of composition A (which cannot be added), and filler a accounts for the remaining part of composition A.

The component B is divided into polydimethylsiloxane, alkoxysilane, pigment b (which cannot be added), filler b, and additives, wherein the polydimethylsiloxane accounts for 20% to 60% of the weight of composition B, alkoxysilane accounts for 1% to 10% of the weight of composition B, pigment b accounts for 0% to 2% (which cannot be added) of the weight of composition B, additives accounts for 1% of the weight of composition B, and filler b accounts for the remaining part of composition B.

Preferably, the method for adhering sound-absorbing material layer to noise-reducing tire further comprises the following steps:
a first step of configuring composition A and composition B separately and storing composition A and composition B in separate containers;
a second step of setting the quantitative glue discharging device at the end of the feed pump, and using the feed pump to drive composition A and composition B into quantitative glue discharging device respectively;
a third step of using quantitative glue discharging device to inject composition A and composition B into the mixing tube according to a preset volume ratio for mixing, which are mixed at the glue gun installed on the tooling equipment;
a fourth step of controlling the movement path of glue gun by either program control, manual control or by combination of both, and coating two-component silica gel on the inner wall of the tire, and
a fifth step of importing the sound-absorbing material layer into the interior of the tire which needs to be adhered, laminating sound-absorbing material layer to inner wall surface of the tire so that the both are fully adhered, and then transferring the tire to next station to wait for curing to be completed.

Preferably, the cross section extruded by the glue gun is a cylindrical adhesive tape with a diameter of 0.1 to 15 mm, or an equivalent amount of glue in other shape.

Preferably, the apparatus of the method for adhering sound-absorbing material layer to noise-reducing tire comprises:
the first feed pump which is used to transport composition A, wherein the liquid inlet end of the first feed pump is connected to the container containing composition A, and the liquid outlet end is connected to the quantitative glue discharging device;
the second charging pump which is used to transport composition B, wherein the liquid inlet end of the second feed pump is connected to the container containing composition B, and the liquid outlet end is connected to the quantitative glue discharging device;
the quantitative glue discharging device which has two liquid inlets and two liquid outlets, wherein two liquid inlets are connected to the liquid outlets of the first feed pump and the second feed pump respectively, and the two liquid outlets are connected to the glue valve;
the glue valve which has two inlets and one outlet, wherein two inlets are connected to the two liquid outlets of the quantitative glue discharging device, and the outlet is connected to the glue gun, and
the glue gun which is installed on the tooling equipment and discharge the glue from the pipe and adhere it to the inner wall of the tire.

Preferably, the quantitative glue discharging device is provided with one set, and the composition stored in quantitative device is quantitatively outputted until the storage amount of composition reaches the threshold value of the glue replenishment position set by the apparatus, then the glue will be replenished automatically/manually through the program.

Preferably, the quantitative glue discharging device is provided with at least two sets. When one set of quantitative glue discharging device is discharging glue, the feed pump replenishes glue liquid in remaining quantitative glue discharging device(s), and each set of quantitative glue discharging device operates alternately to implement continuous quantitative output of glue liquid. The quantitative glue discharging device is provided with at least two sets and each quantitative glue discharging device is connected in parallel with each other.

### Beneficial Effect

The present invention provides a method and an apparatus for adhering sound-absorbing material layer to noise-reducing tire, which has the following beneficial effects.
1. The present invention uses two-component silica gel as the adhesive between the tire body and the sound-absorbing cotton, thereby greatly shortening the entire processing time of sound-absorbing cotton. The curing time of coating two-component silica gel is reduced by 50% compared to the traditional process, with the overall curing time less than 24 hours. The sound-absorbing layer will not fall or shift during the movement of the tire, and the end of the layer will not tear.
2. The present invention uses two-component silica gel as the adhesive for coating processing, which greatly reduces the curing time, and no harmful substances are added to the ingredients which can avoid physical damage to workers during production.
3. The present invention adopts extrusion processing technique, which avoids irregular movement of the glue material and increases adhesion. This also improves the initial adhesion of the glue material, and avoids the displacement of the sound-absorbing cotton in the initial processing stage, and improves the processing stability, and further improves the stability of the quality of the manufactured product.

### DESCRIPTION OF DRAWINGS

FIG. 1 is a schematic diagram of a glue injection apparatus provided by an embodiment of the present invention.

FIG. 2 is a schematic structural diagram of a glue gun and tooling equipment provided by an embodiment of the present invention.

FIG. 3 is a schematic diagram of one of the glue coating methods provided by the embodiment of the present invention.

FIG. 4 is a schematic diagram of another glue coating method provided by an embodiment of the present invention.

FIG. 5 is a schematic diagram of the adhesive structure of one of the sound-absorbing material layers provided by the embodiment of the present invention.

FIG. 6 is a schematic diagram of the adhesive structure of another sound-absorbing material layer provided by the embodiment of the present invention.

FIG. 7 is a graph showing the change of the solidification depth of the single-component glue with time, temperature and humidity in the prior art.

FIG. 8 is a graph showing the change of the solidification depth of the two-component glue of the present invention with time, temperature, and humidity.

FIG. 9 is a stereogram of a quantitative glue discharging device provided by the embodiment of the present invention.

FIG. 10 is a front view of the quantitative glue discharging device provided by the embodiment of the present invention.

Among them: 11. first piston pump; 12. second piston pump; 20. quantitative glue discharging device; 21. liquid inlet; 22. liquid outlet; 30. glue valve; 40. glue gun; 50. tooling equipment; 60. tire; 61. sound-absorbing material layer; 62. glue strip.

### DETAILED DESCRIPTION OF THE EMBODIMENTS

In the technical solutions in the embodiments of the present invention will be clearly and completely described below with reference to the accompanying drawings in the embodiments of the present invention. Obviously, the described embodiments are only some of the embodiments of the present invention, rather than all the embodiments. Based on the embodiments of the present invention, all other embodiments obtained by those of ordinary skill in the art without creative efforts fall within the scope of protection of the present invention.

### Embodiment 1

As shown in the drawing, a method and an apparatus for adhering a sound-absorbing material layer on a noise-reducing tire. The tire body and the sound-absorbing material layer preparation process is that the tire body needs to be thoroughly cleaned before manufacturing to ensure that the inner wall is free of dust, grease or other contaminants. The key to the selection of sound-absorbing layer materials lies in their noise and shock-absorbing performance. Usually, materials with moderate thickness and good sound-absorbing properties are selected, such as special foam or composite materials. These materials need to be cut to fit the tire size before being fitted.

For the preparation and application of composite silica gel, it consists of two parts: Composition A and Composition B. Composition A mainly consists of polydimethylsiloxane, pigments (such as titanium oxide or iron oxide) and fillers (such as calcium carbonate). Composition B includes polydimethylsiloxane, alkoxysilane (such as vinyltrimethoxysilane) and corresponding fillers. These two compositions need to be prepared separately and stored in separate containers before use.

In the adhesion step, firstly use the feed pump to drive the two compositions into the quantitative glue dispensing device. It needs to be clear that the feed pump includes a plunger pump, a pressure pump and other structures that can arbitrarily realize the feeding of the composition. Suitable pumps or other products can be selected according to actual needs. The device will inject the two compositions into the mixing tube at a preset volume ratio for mixing. The mixed glue is evenly applied to the inner wall of the tire through the mixing tube glue gun installed on the tooling equipment. This step requires precise control to ensure that the glue layer is even, bubble-free and fully covered. The work equipment includes but is not limited to robotic arms, robots, or other work equipment.

For the adhesion and curing of the sound-absorbing material layer, after adhering the adhesive layer, the prepared sound-absorbing material layer is input into the inside of the tire through a special track apparatus. Before the glue layer is cured, accurately compact the sound-absorbing material layer to the inner wall of the tire to ensure that there is no gap between the sound-absorbing material layer and the glue layer. After completing this step, the tire moves to the next station for curing.

During the curing process, the tire is kept in a controlled temperature and humidity environment for a certain period of time to ensure that the glue layer is completely hardened and the sound-absorbing material layer is firmly bonded to the inner wall of the tire. The length of curing time depends on the properties of the silicone used and environmental conditions.

For quality control, it is essential throughout the manufacturing process. After the glue is coated, the thickness, uniformity and color of the glue layer need to be checked to ensure that the mixture is even and flawless. After the sound-absorbing material layer is adhered, its adhesion strength and position accuracy are inspected. In addition, the completed tire should undergo acoustic testing to verify that its noise reduction performance meets expected standards.

For safety and environment, during the whole manufacturing process, operators should wear appropriate personal protective equipment, such as protective gloves and glasses, to prevent direct contact with the glue. At the same time, it is necessary to ensure that the workshop is well ventilated to avoid the accumulation of harmful gases. All waste and residues should be disposed of in accordance with environmental regulations to reduce environmental impact.

### Embodiment 2

As shown in drawings, a method for adhering sound-absorbing material layer to noise-reducing tire, comprises:

tire body which is used as base material for adhering;
sound-absorbing material layer which is used for absorbing the noise generated by operation of the tire body, and
an adhesive layer which is coated between tire body and sound-absorbing material layer.

The method for adhering sound-absorbing material layer to noise-reducing tire includes following steps:
a first step of preparing the tire body, cleaning the inner wall of the tire by laser cleaning and other cleaning methods, making the inner wall of the tire clean and dust-free;
a second step of testing the inner wall of the tire;
a third step of coating the adhesive layer on the inner wall of the tire body;
a fourth step of testing the glue coating effect, and
a fifth step of laminating sound-absorbing material layer to inner wall surface of the tire and adhering it to the tire through adhesive layer.

A method for adhering sound-absorbing material layer to noise-reducing tire, which is:
the adhesive layer is made of two-component silica gel, wherein the mixture of two-component silica gel is divided into component A and component B;
the Component A is divided into polydimethylsiloxane, pigment a (which cannot be added) and filler a, wherein the polydimethylsiloxane accounts for 30% to 60% of the weight of composition A, pigment a accounts for 0% to 2% of the weight of composition A (which cannot be added), and filler a accounts for the remaining part of composition A, and
the component B is divided into polydimethylsiloxane, alkoxysilane, pigment b (which is no need be added), filler b, and additives, wherein polydimethylsiloxane accounts for 20% to 60% of the weight of composition B, alkoxysilane accounts for 1% to 10% of the weight of composition B, pigment b accounts for 0% to 2% (which is no need to be added) of the weight of composition B, additives accounts for 1% of the weight of composition B, and filler b accounts for the remaining part of composition B.

A method for adhering sound-absorbing material layer to noise-reducing tire further comprises the following steps:
a first step of configuring composition A and composition B separately and storing composition A and composition B in separate containers;
a second step of setting the quantitative glue discharging device at the end of the feed pump, and using the feed pump to drive composition A and composition B into quantitative glue discharging device respectively;
a third step of using quantitative glue discharging device to inject composition A and composition B into the mixing tube according to a preset volume ratio for mixing, wherein composition A and composition B are mixed at the glue gun installed on the tooling equipment;
a fourth step of controlling the movement path of glue gun by either program control, manual control or by combination of both, and coating two-component silica gel on the inner wall of the tire, and
a fifth step of importing the sound-absorbing material layer into the interior of the tire which needs to be adhered, laminating sound-absorbing material layer to inner wall surface of the tire so that the both are fully adhered, and then transferring the tire to next station to wait for curing to be completed.

The cross section extruded by the glue gun is a cylindrical glue strip with a diameter of 0.1 mm to 15 mm, or an equivalent amount of glue in other shape. There are at least two sets of quantitative glue discharging device. When one of quantitative glue discharging device is discharging glue, the charging pump supplements the glue in the other discharging device. Each set of quantitative glue discharging device run alternately to continuously discharge quantitative glue.

The apparatus for adhering sound-absorbing material layer to noise-reducing tire which is comprised of:
the first piston pump which is used to transport composition A, wherein the liquid inlet end of the first feed pump is connected to the container containing composition A, and the liquid outlet end is connected to the quantitative glue discharging device;
the second piston pump which is used to transport composition B, wherein liquid inlet end of the second feed pump is connected to the container containing composition B, and the liquid outlet end is connected to the quantitative glue discharging device;
the quantitative glue discharging device which has two liquid inlets and two liquid outlets, wherein the two liquid inlets are connected to the liquid outlets of the first feed pump and the second feed pump respectively, and the two liquid outlets are connected to the glue valve;
the glue valve which has two inlets and one outlet, wherein the two inlets are connected to the two liquid outlets of the quantitative glue discharging device, and the outlet is connected to the glue gun, and
the glue gun which is installed on the tooling equipment and discharge the glue from the pipe and adhere it to the inner wall of the tire, wherein the quantitative glue discharging device is provided with one set, and the composition stored in quantitative device is quantitatively outputted until the storage amount of composition reaches the threshold value of the glue replenishment position set by the apparatus, then the glue will be replenished automatically/manually through the program.

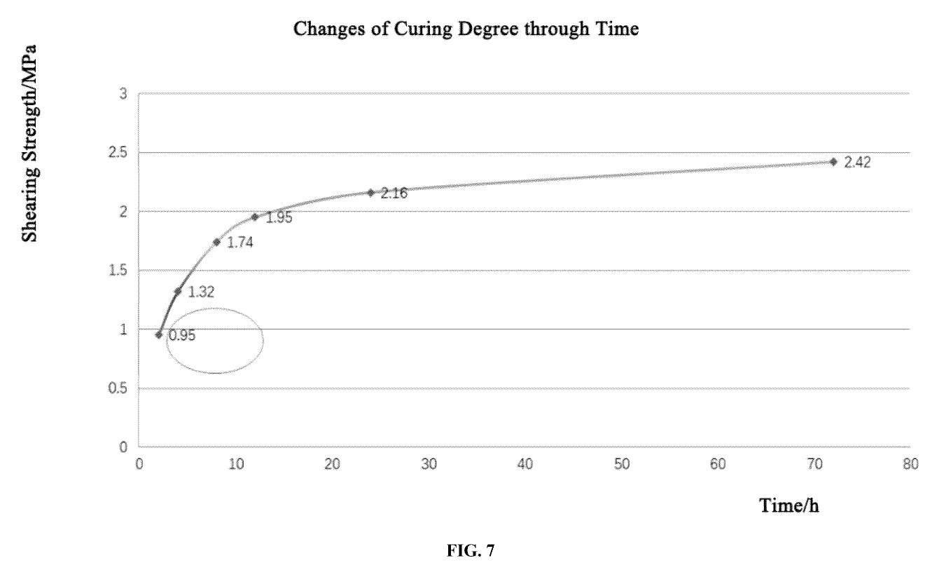

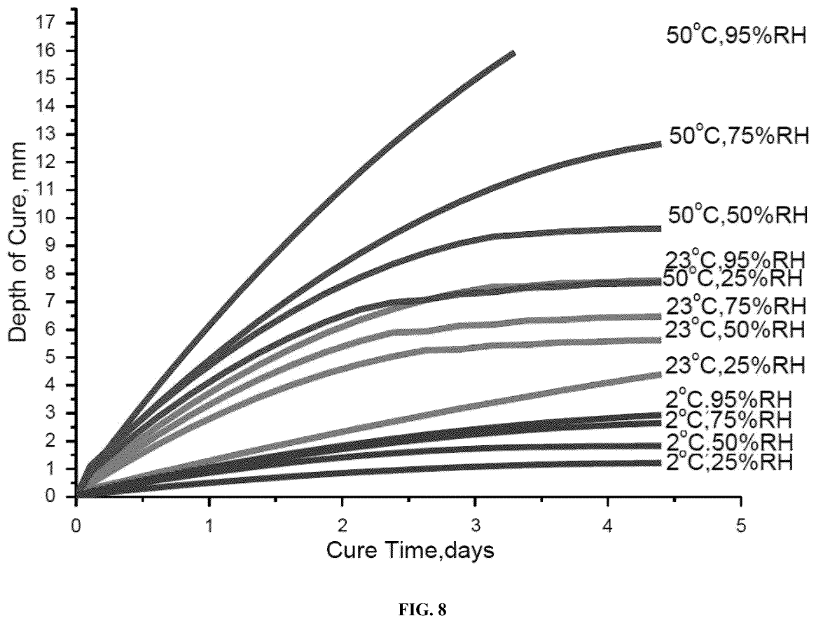

As shown in FIGS. 7 and 8, the data can reveal the difference in performance between the product containing components A and B and the common product containing single component, which can help tire enterprises shorten curing waiting time by more than 50% and reduce inventory as well as management costs.

The viscosity of each component of the two-component adhesive is between 50,000 and 200,000 mPa·s (room temperature), and the ratio of composition A and composition B is 10:1 to 1:10 (volume ratio). Typical colors are white, black, or two different colors. After mixing, a third color is formed, which facilitates visual identification and detection (whether the mixture is evenly mixed) and is more conducive to online inspection and quality control of the production line. The density of each component of the two-component adhesive and its mixture is 1.0 to 1.8 g/cm³.

Compared with single-component silica gel, two-component silica gel can form initial adhesion strength within 2 to 10 minutes, and the thickness of the adhesive layer is 0.1 mm to 10 mm and the overall solidification is rapid. The higher the temperature, the faster the curing, and it is not affected by environmental humidity. The production line can produce efficiently in order to quickly enter the next step. It reaches a high adhesion strength of 0.9 MPa in about 2 hours at room temperature.

The test data shown in FIG. 8 is based on the following components:

Composition A

| | | Iron | Calcium | Silica |
|---|---|---|---|---|
| Composition | Polydimethylsiloxane | Oxide | Carbonate | Powder |
| Parts by Weight | 36 | 1.3 | 55 | 7.7 |

### Composition B

| | Poly- | Methyl- | | | |
|---|---|---|---|---|---|
| | dimethyl- | trimeth- | Iron | Calcium | Silica |
| Composition | siloxane | oxysilane | Oxide | Carbonate | Powder |
| Parts by | 25 | 15 | 1.5 | 50 | 8.5 |
| Weight | | | | | |

### Two-Component Silica Gel

| Composition | Composition A | Composition B |
|---|---|---|
| Parts by Volume | 3 | 1 |

### Embodiment 3

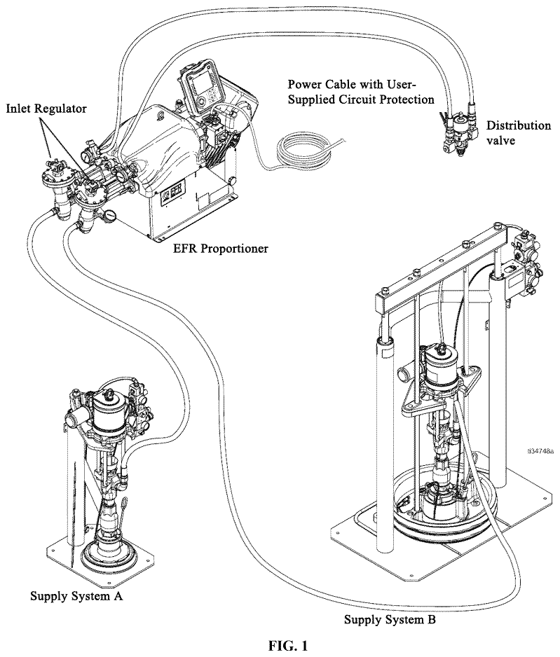

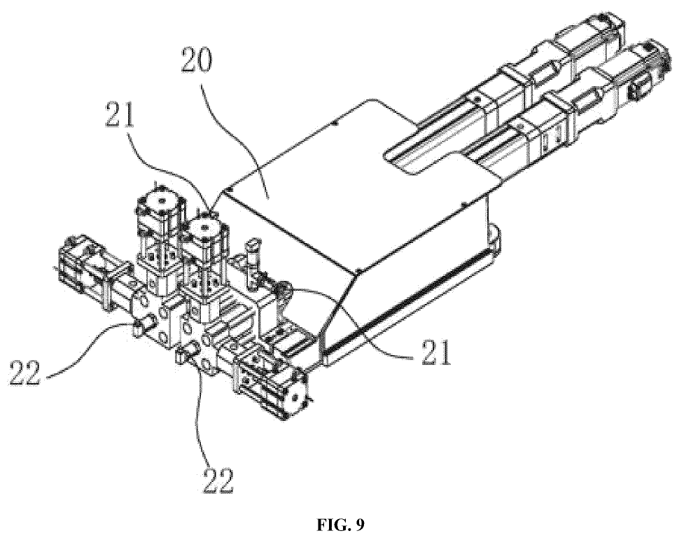

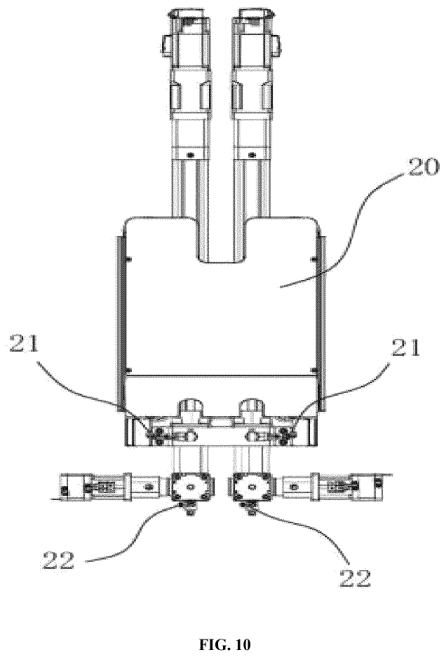

As shown in FIG. 1, the gluing apparatus for adhering sound-absorbing material layer to noise-reducing tire which is comprised of:
the first piston pump 11 which is used to transport composition A, wherein the liquid inlet end of the first piston pump 11 is connected to the container containing the composition A, and the liquid outlet end is connected to the quantitative glue discharging device 20;
the second piston pump 12 which is used to transport composition B, wherein the liquid inlet end of the first piston pump 11 is connected to the container containing composition B, and the liquid outlet end is connected to the quantitative glue discharging device 20;
the quantitative glue discharging device 20 as shown in FIGS. 9 and 10, which has two liquid inlets 21 and two liquid outlets 22, wherein two liquid inlets are respectively connected with the liquid outlets of the first piston pump 11 and the second piston pump 12, wherein he two liquid outlets 22 are connected with the glue valve 30, and the end of the glue valve 30 is provided with a mixing discharge pipe. The specific structure and principle of the quantitative glue discharging device 20 are available from the prior art such as the patent titled A Quantitative Glue Dispenser for the Production of New Energy Power Batteries (No.: 201921065808.2) or the patent titled An Automatic Detection Mechanism for Quantitative Cylinder Leakage and Quantitative Glue Dispenser (No.: 202021346561.4), which is not detailed herein.

The glue valve 30 has two inlets and one outlet, wherein the two inlets are respectively connected with the two liquid outlets 22 of the quantitative glue discharging device 20, and the outlet is connected with the glue gun 40, and
the glue gun 40 is installed on the tooling equipment 50 and is used to discharge the glue liquid from the pipeline and to adhere it to the inner wall of the tire 60.

As shown in FIG. 1, there are at least two groups of quantitative glue discharging devices 20. Each quantitative glue discharging device 20 is connected in parallel. The quantitative glue discharging devices 20 can also be provided in groups until the storage amount of the composition reaches the threshold of replenishing glue amount position set by the apparatus. After the threshold is reached, the glue is replenished automatically/manually through the program, which further illustrates the operation process of the entire technical solution. The solution can be a single group of metering output or multiple groups of metering output, since the metering cylinder capacity of the metering apparatus is limited. Through this solution, after the output of A and B glue in one metering apparatus is completed, the A and B glues are seamlessly switched, and at the same time, the previous metering apparatus starts to refill the A and B glues. This cycle achieves the effect of continuous output of glue at the front end and continuous output of two-component silica gel. The proportioned A and B glues are inputted to the mixing pipe through the glue valve 30 at the front end for mixing, and then finally output to the parts to be coated on.

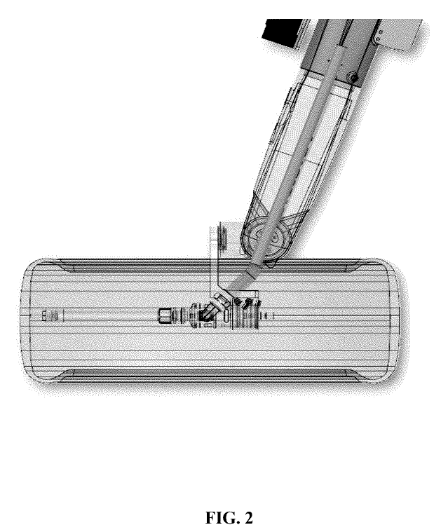

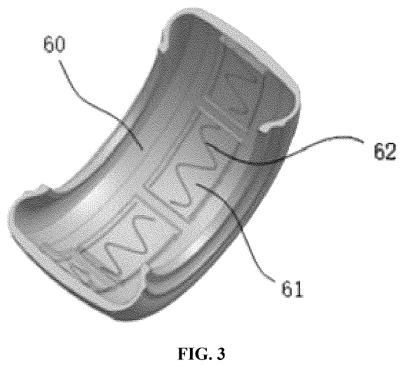

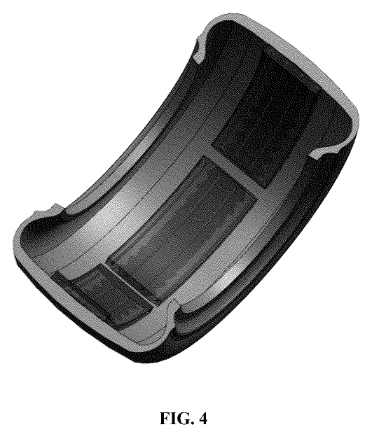

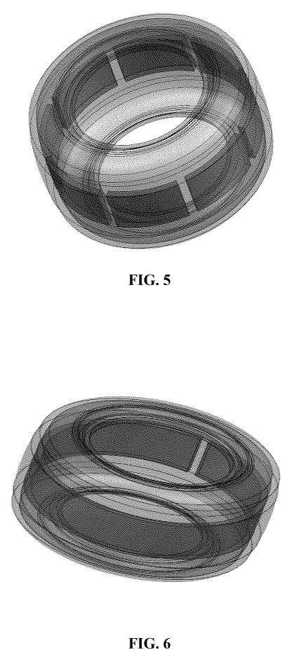

As shown in FIG. 2, the glue valve 30 at the front is installed on the machine arm, and the glue A and B that have been accurately quantified and mixed are coated through the path required for glue coating through program control. The coating process can be that the tire 60 rotates and the tooling equipment 50 moves slightly within a certain range according to the trajectory. It can also be that the tire 60 is fixed and the tooling equipment 50 directly follows the trajectory to complete the coating route. As shown in FIGS. 3 and 4, the diameter of the coated A and B glue strips 62 is generally 0.1 mm to 15 mm, and the shape is indefinite. It can be a strip, a rectangle or other shapes, and the trajectory can also be straight or curved in shape.

### Embodiment 4

A method for adhering sound-absorbing material layer to noise-reducing tire which is comprised of:
tire body which is used as base material for adhering;
the sound-absorbing layer which is used to absorb the noise generated by operation of the tire body, and
the adhesive layer, which is made of two-component silica gel, is coated between tire body and sound-absorbing material layer.

The Method for adhering sound-absorbing material layer to noise-reducing tire includes following steps:
a first step of preparing the tire body, cleaning the inner wall of the tire by laser cleaning and other cleaning methods, making the inner wall of the tire clean and dust-free;
a second step of coating the adhesive layer on the inner wall of the tire body;
a third step of testing the glue coating effect, and
a fourth step of laminating sound-absorbing material layer to inner wall surface of the tire and adhering it to the tire through adhesive layer which is two-component silica gel, wherein the two-component silica gel mixture is divided into component A and component B. Component A consists of polydimethylsiloxane, pigment a and filler a, wherein the polydimethylsiloxane accounts for 30% to 60% of the weight of composition A, pigment a for 1% to 2%, and filler a for the remaining part of composition A, and

Component B consists of polydimethylsiloxane, alkoxysilane, pigment b and filler b, wherein Polydimethylsiloxane accounts for 20% to 60% of the weight of the composition B, alkoxysilane accounts for 10% to 20% of the weight of composition B and pigment b accounts for 1% to 2% of the weight of composition B. The remaining component of composition B is filler b.

### Embodiment 5

A further disclosed technical solution for adhering sound-absorbing material layer to noise-reducing tire. The adhesive layer is a multi-component mixture. In the previous embodiment, the component mixture includes component A and component B. In this embodiment, the adhesive layer is further disclosed to be multi-component mixture, and the components include but are not limited to component A and component B in the previous embodiment. Other equivalent substitute products which adjust, enhance, and modify the performance of the adhesive layer or other multi-component glue which produces similar effects can also be adjusted or added.

It should be noted that in this document, relational terms such as first and second and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Although embodiments of the invention have been shown and described, it is to be understood that various modifications and substitutions, as well as rearrangements of parts and components, can be made thereto by one skilled in the art without departing from the scope or spirit of the invention, and a reasonable equivalency thereof.

What is claimed is:

1. A method for adhering sound-absorbing material layer to noise-reducing tire, characterized in that the method for adhering sound-absorbing material layer to noise-reducing tire consists of:
tire body which is used as base material for adhering;
sound-absorbing material layer which is used for absorbing the noise generated by operation of the tire body, and
an adhesive layer which is coated between tire body and sound-absorbing material layer, and a method for adhering sound-absorbing material layer to noise-reducing tire includes following steps:
a first step of preparing the tire body;
a second step of coating the adhesive layer on the inner wall of the tire body, and
a third step of laminating the sound-absorbing material layer to inner wall surface of the tire and adhering it to the tire through adhesive layer, wherein
the adhesive layer is made of mixture of silica gel which consists of two or more components.

2. A method for adhering sound-absorbing material layer to noise-reducing tire according to claim 1, is characterized in that:
the adhesive layer is made of two-component silica gel, wherein the mixture of two-component silica gel is divided into component A and component B;
the component A is divided into polydimethylsiloxane, pigment a (which cannot be added) and filler a, wherein the polydimethylsiloxane accounts for 30% to 60% of the weight of composition A, pigment accounts for 0% to 2% of the weight of composition A (which cannot be added), and filler accounts for the remaining part of composition A, and
the component B is divided into polydimethylsiloxane, alkoxysilane, pigment b (which is no need be added), filler b, and additives, wherein the polydimethylsiloxane accounts for 20% to 60% of the weight of composition B, alkoxysilane accounts for 1% to 10% of the weight of composition B, pigment b accounts for 0% to 2% (which is no need to be added) of the weight of composition B, additives accounts for 1% of the weight of composition B, and filler b accounts for the remaining part of composition B.

3. A method for adhering sound-absorbing material layer to noise-reducing tire according to claim 1, is characterized in that the method for adhering sound-absorbing material layer to noise-reducing tire is further comprised of the following steps:
a first step of configuring composition A and composition B separately and storing composition A and composition B in separate containers;
a second step of setting the quantitative glue discharging device at the end of the feed pump, and using the feed pump to drive composition A and composition B into quantitative glue discharging device respectively;
a third step of using quantitative glue discharging device to inject composition A and composition B into the mixing tube according to a preset volume ratio for mixing, wherein composition A and composition B are mixed at the glue gun installed on the tooling equipment;
a fourth step of controlling the movement path of glue gun by either program control, manual control or by combination of both, and coating two-component silica gel on the inner wall of the tire, and
a fifth step of importing the sound-absorbing material layer into the interior of the tire which needs to be adhered, laminating sound-absorbing material layer to inner wall surface of the tire so that the both are fully adhered, and then transferring the tire to next station to wait for curing to be completed.

4. A method for adhering sound-absorbing material layer to noise-reducing tire according to claim 3, is characterized in that the cross-section extruded by the glue gun is a cylindrical rubber strip with a diameter of 0.1 mm to 15 mm or an equivalent amount of glue in other shapes.

5. An apparatus for adhering sound-absorbing material layer to noise-reducing tire according to claim 4, is characterized in that the apparatus is comprised of:
the first feed pump which is used to transport composition A, wherein the liquid inlet end of the first feed pump is connected to the container containing composition A, and the liquid outlet end is connected to the quantitative glue discharging device;
the second charging pump which is used to transport composition B, wherein the liquid inlet end of the second feed pump is connected to the container containing composition B, and the liquid outlet end is connected to the quantitative glue discharging device;
the quantitative glue discharging device which has two liquid inlets and two liquid outlets, wherein the two liquid inlets are connected to the liquid outlets of the first feed pump and the second feed pump respectively, and the two liquid outlets are connected to the glue valve;
the glue valve which has two inlets and one outlet, wherein the two inlets are connected to the two liquid outlets of the quantitative glue discharging device, and the outlet is connected to the glue gun, and
the glue gun which is installed on the tooling equipment and discharge the glue from the pipe and adhere it to the inner wall of the tire.

6. An apparatus for adhering sound-absorbing material layer to noise-reducing tire according to claim 5, is characterized in that the quantitative glue discharging device is provided with one set, and the composition stored in quantitative device is quantitatively outputted until the storage amount of composition reaches the threshold value of the glue replenishment position set by the apparatus, then the glue will be replenished automatically/manually through the program.

7. An apparatus for adhering sound-absorbing material layer to noise-reducing tire according to claim 5, is characterized in that the quantitative glue discharging device is provided with at least two sets; when one set of quantitative glue discharging device is discharging glue, the feed pump replenishes glue liquid in remaining quantitative glue discharging device(s), and each set of quantitative glue discharging device operates alternately to implement continuous quantitative output of glue liquid; the quantitative glue discharging device is provided with at least two sets and each quantitative glue discharging device is connected in parallel with each other.
